(19) United States
(12) Patent Application Publication
(10) Pub. No.: US 2026/0369606 A1
(43) Pub. Date: Nov. 19, 2026

(54) ELECTRODE ASSEMBLY AND RECHARGEABLE LITHIUM BATTERY INCLUDING THE SAME

(71) Applicant: SAMSUNG SDI CO., LTD., Yongin-si, Gyeonggi-do (KR)

(72) Inventors: Myeonghun LEE, Yongin-si (KR); Tae Jin LEE, Yongin-si (KR); Yeonji LEE, Yongin-si (KR); Kyeongtak CHOI, Yongin-si (KR)

(21) Appl. No.: 19/260,147

(22) Filed: Jul. 3, 2025

(30) Foreign Application Priority Data
Oct. 2, 2024 (KR) 10-2024-0134254

(51) Int. Cl. H01M 4/62; H01M 4/02; H01M 4/36; H01M 10/0525; H01M 10/0567; H01M 10/0568; H01M 10/0569; H01M 50/449

(52) U.S. Cl. CPC H01M 4/622; H01M 4/366; H01M 10/0525; H01M 10/0567; H01M 10/0568; H01M 10/0569; H01M 50/449; H01M 2004/021; H01M 2300/004; H01M 2300/0051

(57) ABSTRACT

Provided is an electrode assembly and a rechargeable lithium battery including the same, and, for example, the electrode assembly may include a positive electrode, a negative electrode, and a separator between the positive electrode and the negative electrode, a coating layer may be provided onto one side of at least one of the positive electrode, the negative electrode, or the separator, and the coating layer may include a first compound represented by Formula 1 below, Formula 2 below, or Formula 3 below. Details of Formulas 1, 2, and 3 are as described in the specification.

### CROSS-REFERENCE TO RELATED APPLICATION

The present application claims priority to and the benefit of Korean Patent Application No. 10-2024-0134254, filed on Oct. 2, 2024, in the Korean Intellectual Property Office, the entire content of which is hereby incorporated by reference.

### BACKGROUND

Embodiments of the present disclosure herein relate to an electrode assembly and a rechargeable lithium battery including the same.

Recently, with the rapid spread of battery-using electronic devices, such as mobile phones, laptop computers, and electric vehicles, interest in a rechargeable battery having high energy density and high capacity has rapidly increased. Accordingly, research and development has been actively conducted to improve performance of the rechargeable lithium battery.

The rechargeable lithium battery includes a positive electrode and a negative electrode containing active materials capable of intercalation and deintercalation of lithium ions, and an electrolyte solution. Electrical energy is produced by oxidation and reduction reactions if (e.g., when) the lithium ions are intercalated and deintercalated into/from the positive electrode and the negative electrode.

### SUMMARY

Embodiments of the present disclosure provide an electrode assembly capable of preventing explosion and ignition (or reducing an occurrence, likelihood, or degree thereof) of a battery if (e.g., when) the battery is exposed to high temperature, and preventing or reducing a temperature increase of the battery, and thus having improved thermal safety and improved lifespan characteristics, and provides a rechargeable lithium battery including the same.

An embodiment of the present disclosure provides an electrode assembly including a positive electrode, a negative electrode, and a separator between the positive electrode and the negative electrode, wherein a coating layer is provided to one side of at least one selected from among the positive electrode, the negative electrode, and the separator, and the coating layer may include a first compound represented by Formula 1 below, Formula 2 below, or Formula 3 below.

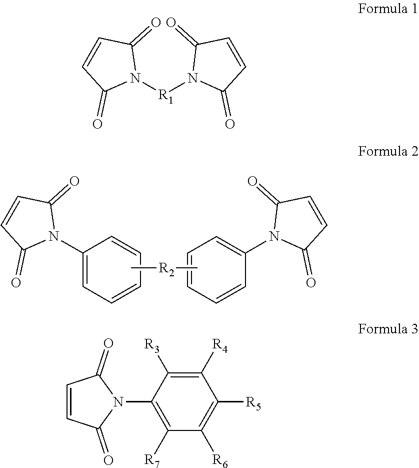

In Formula 1 above, R₁ may be a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)O—, a substituted or unsubstituted phenylene group, or a substituted or unsubstituted biphenylene group, R may be a C1 to C4 alkylene group, and R′ may be a C1 to C4 alkylene group,
in Formula 2 above, R₂ may be a substituted or unsubstituted C1 to C4 alkylene group, —C(O)—, —C(CH₃)₂—, —O—, —O—O—, —S—, —S—S—, —(O)S(O)—, or —S(O)—, and
in Formula 3 above, R₅ to R₇ may be each independently hydrogen, halogen, a substituted or unsubstituted C1 to C6 alkyl group, a substituted or unsubstituted C2 to C6 alkenyl group, a substituted or unsubstituted C6 to C18 aryl group, a substituted or unsubstituted C1 to C6 ether group, or a substituted or unsubstituted C1 to C6 alkoxy group.

In an embodiment of the present disclosure, a rechargeable lithium battery includes the electrode assembly previously described, and an electrolyte solution, and the electrolyte solution may include a non-aqueous organic solvent, a lithium salt, and an additive, and the additive may include a second compound represented by Formula 4 below.

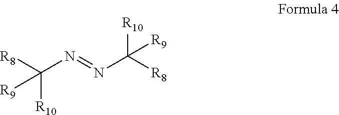

In Formula 4 above, R₈ to R₁₀ may be each independently hydrogen; a cyano group; halogen; or a substituted or unsubstituted C1 to C10 hydrocarbon group including an alkyl group, a cycloalkyl group, an alkoxy group, a carboxy group, an ester group, a carbonyl group, an amide group, or a hydroxy group, or a combination thereof.

R₈ to R₁₀ may each exist independently, or at least two thereof may be connected to each other to form a substituted or unsubstituted monocyclic or polycyclic aliphatic ring.

### BRIEF DESCRIPTION OF THE DRAWINGS

The accompanying drawings are included to provide a further understanding of the subject matter of the present disclosure, and are incorporated in and constitute a part of this specification. The drawings illustrate embodiments of the present disclosure and, together with the description, serve to explain principles of the present disclosure. In the drawings:

FIG. 1 is a simplified conceptual diagram illustrating a rechargeable lithium battery according to embodiments of the present disclosure;

FIGS. 2-5 are schematic views each illustrating a rechargeable lithium battery according to an embodiment; and

FIGS. 6-9 are exploded cross-sectional views of an electrode assembly according to embodiments of the present disclosure.

### DETAILED DESCRIPTION

In order to fully understand the configuration and effect of the subject matter of the present disclosure, embodiments of the present disclosure will be described below in more detail with reference to the accompanying drawings. The present disclosure may, however, be embodied in various suitable forms and should not be construed as limited to the embodiments set forth herein, and various suitable changes and modifications can be made. Rather, these embodiments are provided so that this disclosure will be thorough and complete, and will fully convey the scope of the present disclosure to those skilled in the art to which the present disclosure pertains.

In this specification, it will be understood that, if (e.g., when) an element is referred to as being on another element, the element may be directly on the other element or intervening elements may be present therebetween. In the drawings, thicknesses of components may be exaggerated to effectively explain the technical contents. Like reference numerals or symbols refer to like elements throughout the specification.

The singular forms are intended to include the plural forms as well, unless the context clearly indicates otherwise. In embodiments, unless otherwise specially noted, the phrase “A or B” may indicate “including A but not B, B but not A, or A and B”. The terms “comprises/includes” and/or “comprising/including” used in this description do not exclude the presence or addition of one or more other components.

In this specification, “combination thereof” may refer to a mixture, a stack, a composite, a copolymer, an alloy, a blend, and/or a reaction product of components.

Unless otherwise defined in this specification, a particle diameter may be an average particle diameter. Also, the particle diameter may mean an average particle diameter (D50) which refers to a diameter of particles at a cumulative volume of about 50 vol % in a particle size distribution. The average particle diameter (D50) may be measured by any suitable method generally used in the art, for example, may be measured by a particle size analyzer, and/or may also be measured using a transmission electron microscope (TEM) image and/or a scanning electron microscope (SEM) image. In embodiments, the average particle diameter is measured by a measuring device using dynamic light-scattering, wherein the number of particles is counted for each particle size range by performing data analysis, and an average particle diameter (D50) value may then be obtained by calculation therefrom. Also, the average particle diameter may be measured using a laser diffraction method. If (e.g., when) measured by the laser diffraction method, for example, after dispersing particles to be measured in a dispersion medium, the dispersion medium is introduced into a commercial laser diffraction particle size measurement instrument (e.g., Microtrac MT 3000) and irradiated with ultrasonic waves of about 28 kHz at an output of about 60 W, and the average particle diameter (D50) based on about 50% of particle size distribution in the measurement instrument may then be calculated.

In this specification, unless defined otherwise, “substitution” means that at least one hydrogen of a substituent or a compound is substituted with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In embodiments, “substitution” may mean that at least one hydrogen of a substituent or a compound is substituted with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, “substitution” may mean that at least one hydrogen of a substituent or a compound is substituted with deuterium, a halogen group, a C1 to C20 alkyl group, a C6 to C30 aryl group, a C1 to C10 fluoroalkyl group, or a cyano group. In embodiments, “substitution” may mean that at least one hydrogen of a substituent or a compound is substituted with deuterium, a halogen group, a C1 to C5 alkyl group, a C6 to C18 aryl group, a C1 to C5 fluoroalkyl group, or a cyano group. For example, “substitution” may mean that at least one hydrogen of a substituent or a compound is substituted with deuterium, a cyano group, a halogen group, a methyl group, an ethyl group, a propyl group, a butyl group, a phenyl group, a biphenyl group, a terphenyl group, a trifluoromethyl group, or a naphthyl group.

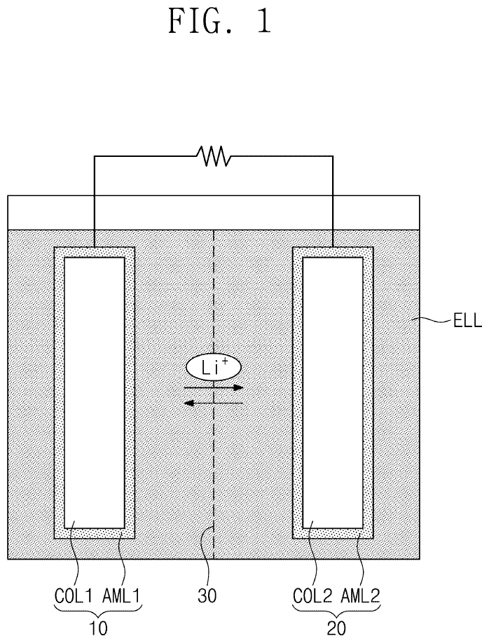

FIG. 1 is a simplified conceptual diagram illustrating a rechargeable lithium battery according to embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other with the separator 30 therebetween. The separator 30 may be between the positive electrode 10 and the negative electrode 20. The positive electrode 10, the negative electrode 20, and the separator 30 may be in contact with the electrolyte solution ELL. The positive electrode 10, the negative electrode 20, and the separator 30 may be impregnated with the electrolyte solution ELL.

The electrolyte solution ELL may be a medium to transfer lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and may further include a binder and/or a conductive material (e.g., an electrically conductive material).

For example, the positive electrode 10 may further include an additive that may serve as a sacrificial positive electrode.

An amount of the positive electrode active material in the positive electrode active material layer AML1 may be about 90 wt % to about 99.5 wt % based on 100 wt % of the positive electrode active material layer AML1. An amount of each of the binder and the conductive material may be about 0.5 wt % to about 5 wt % based on 100 wt % of the positive electrode active material layer AML1.

The binder serves to attach the positive electrode active material particles well to each other and also to attach the positive electrode active material well to the current collector COL1. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, and the like, as non-limiting examples.

The conductive material may be used to impart conductivity (e.g., electrical conductivity) to the electrode. Any suitable material that does not cause chemical change (e.g., does not cause an undesirable chemical change in the rechargeable lithium battery) and conducts electrons may be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc. in a form of a metal powder or a metal fiber; a conductive polymer (e.g., an electrically conductive polymer) such as a polyphenylene derivative; or a mixture thereof.

Al may be used as the current collector COL1, but the material is not limited thereto.

### Positive Electrode Active Material

The positive electrode active material in the positive electrode active material layer AML1 may include a compound (lithiated intercalation compound) that is capable of reversibly intercalating and deintercalating lithium. For example, at least one selected from among a composite oxide of lithium and a metal selected from cobalt, manganese, nickel, and combinations thereof may be used.

The composite oxide may be a lithium transition metal composite oxide. Examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one selected from among the following chemical formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

If (e.g., when) an aqueous binder is used as the negative electrode binder, a cellulose-based compound capable of imparting or increasing viscosity may be further included. The cellulose-based compound may include at least one selected from among carboxymethyl cellulose, hydroxypropylmethyl cellulose, methyl cellulose, or an alkali metal salt thereof. The alkali metal may include Na, K, and/or Li.

The dry binder may be a polymer material that is capable of being fibrous (e.g., capable of being fiberized). For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any suitable material that does not cause chemical change (e.g., does not cause an undesirable chemical change in the rechargeable lithium battery) and conducts electrons may be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer (e.g., an electrically conductive polymer) such as a polyphenylene derivative; or a mixture thereof.

The negative current collector COL2 may include a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, and/or fiber-shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material and/or a Sn-based negative electrode active material. The Si-based negative electrode active material may include silicon, a silicon-carbon composite, SiOx (0<x≤2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon applied onto the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material and/or the Sn-based negative electrode active material may be used in combination with a carbon-based negative electrode active material.

### Separator 30

Depending on the type (or kind) of the rechargeable lithium battery, the separator 30 may be present between the positive electrode 10 and the negative electrode 20. The separator 30 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and/or the like.

The separator 30 may include a porous substrate and a coating layer including an organic material, an inorganic material, or a combination thereof on one or both surfaces (e.g., two opposing surfaces) of the porous substrate.

The porous substrate may be a polymer film formed of any one polymer selected from polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer and/or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

### Electrolyte Solution ELL

The electrolyte solution ELL for a rechargeable lithium battery may include a non-aqueous organic solvent and a lithium salt.

The non-aqueous organic solvent may serve as a medium that transmits ions taking part in the electrochemical reaction of a battery.

The non-aqueous organic solvent may be a carbonate-based, ester-based, ether-based, ketone-based, and/or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In embodiments, the ketone-based solvent may include cyclohexanone, and/or the like. The alcohol-based solvent may include ethanol, isopropyl alcohol, and/or the like, and the aprotic solvent may include nitriles such as R—CN (wherein R is a C2 to C20 linear, branched, or cyclic hydrocarbon group, a double bond, an aromatic ring, and/or an ether bond), and/or the like; amides such as dimethylformamide; dioxolanes such as 1,3-dioxolane, 1,4-dioxolane, and/or the like; sulfolanes, and/or the like.

The non-aqueous organic solvents may be used alone or in combination of two or more.

In embodiments, if (e.g., when) using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, and lithium difluorobis(oxalato)phosphate (LiDFBOP).

### Rechargeable Lithium Battery

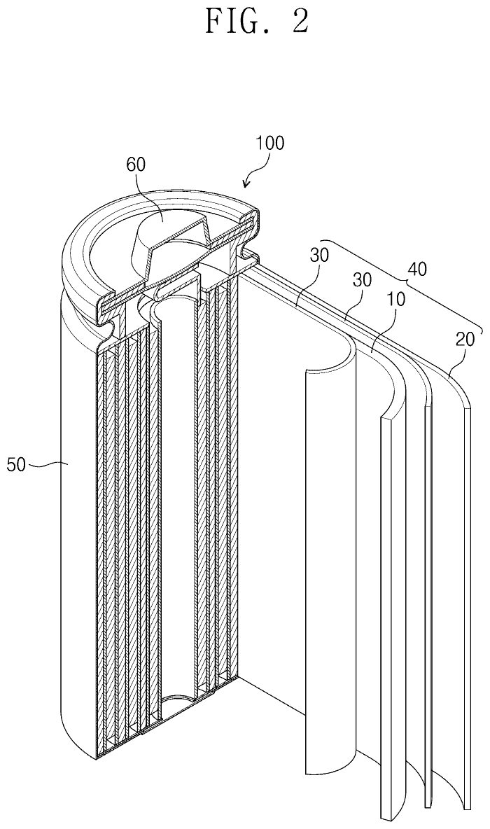

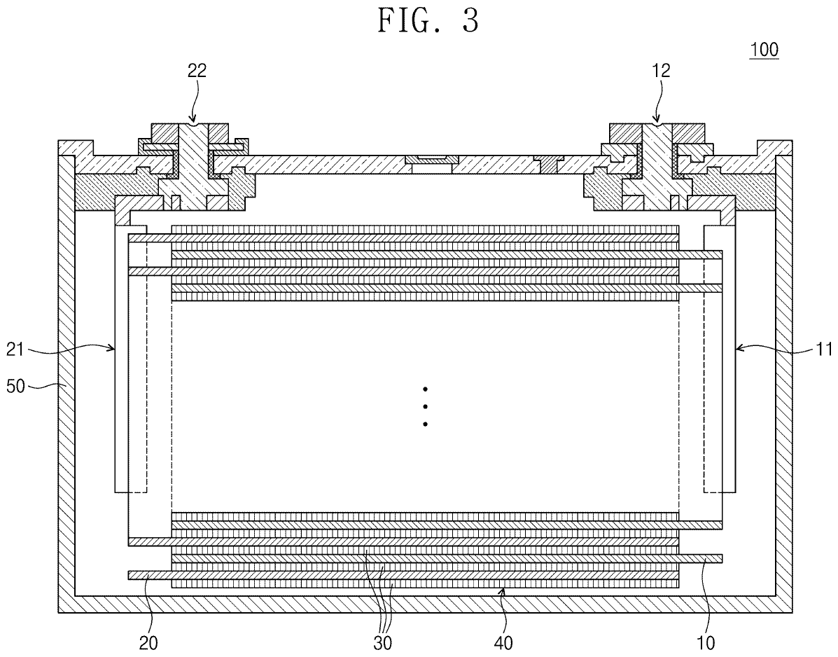

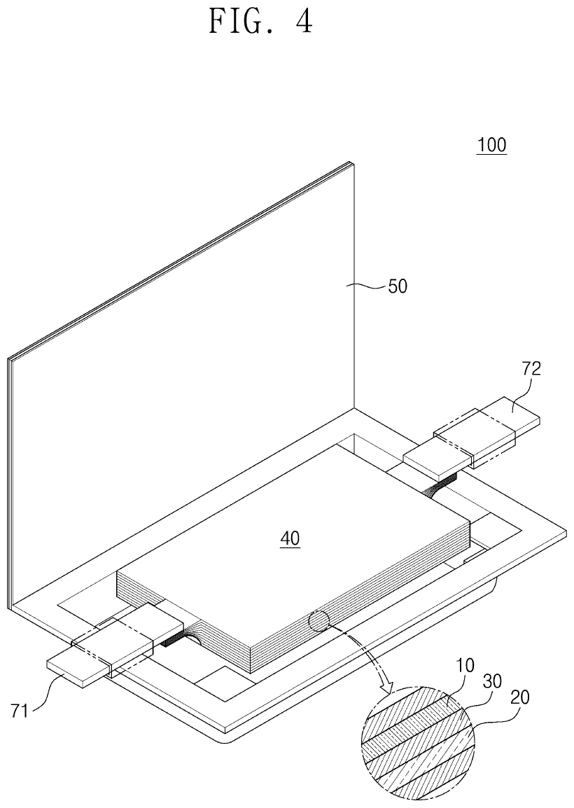

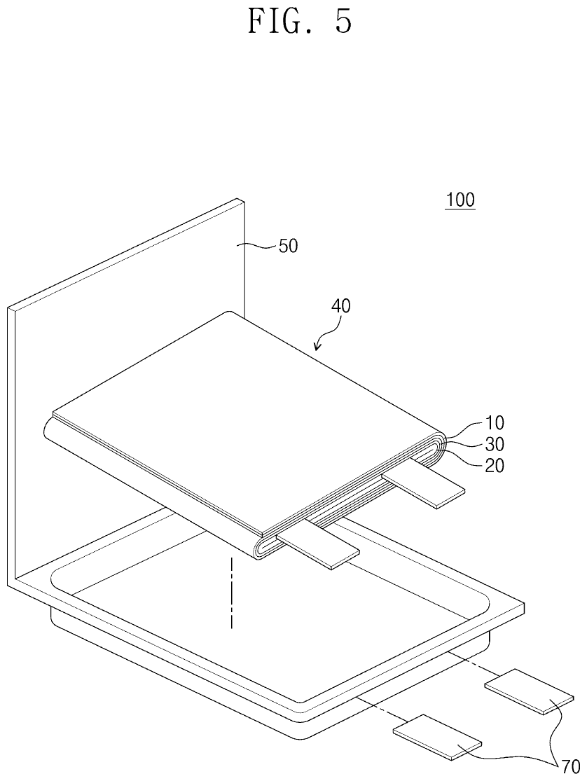

The rechargeable lithium battery may be classified into cylindrical, prismatic, pouch, coin-type batteries, and/or the like depending on their shape. FIGS. 2 to 5 are schematic views illustrating a rechargeable lithium battery according to an embodiment. FIG. 2 shows a cylindrical battery, FIG. 3 shows a prismatic battery, and FIGS. 4 and 5 show pouch-type batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 that seals the case 50, as shown in FIG. 2. In FIG. 3, the rechargeable lithium battery 100 may include a positive electrode lead tab 11, a positive terminal 12, a negative electrode lead tab 21, and a negative terminal 22. As shown in FIGS. 4 and 5, the rechargeable lithium battery 100 may include an electrode tab 70 (FIG. 5), which may be, for example, a positive electrode tab 71 and a negative electrode tab 72 (FIG. 4) that serves as an electrical path to induce the current formed in the electrode assembly 40 to the outside.

The rechargeable lithium battery according to an embodiment of the present disclosure may be applied to automobiles, mobile phones, and/or various suitable types or kinds of electric devices, as non-limiting examples.

Hereinafter, an electrode assembly according to embodiments of the present disclosure will be described in more detail.

### Electrode Assembly

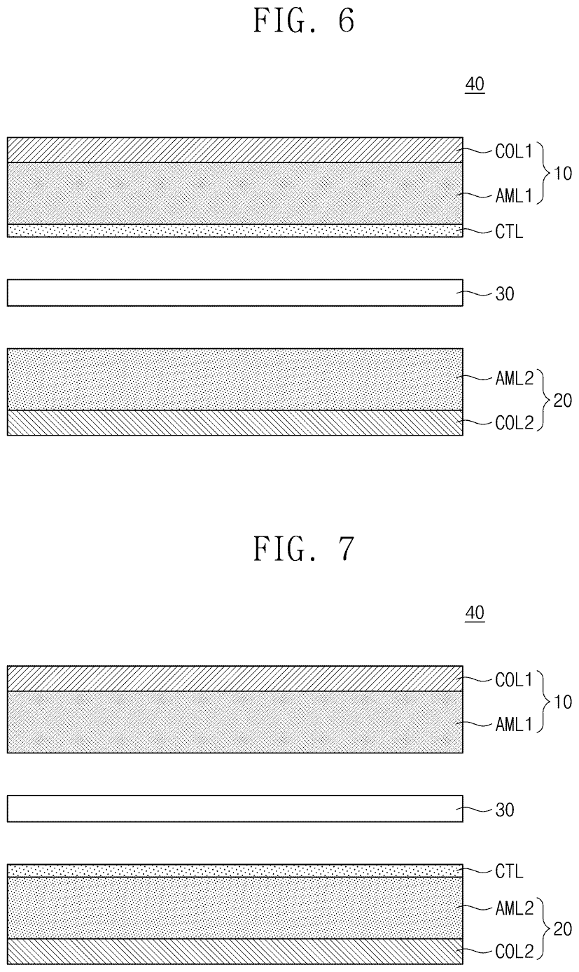

FIGS. 6 to 9 are exploded cross-sectional views of an electrode assembly according to embodiments of the present disclosure.

Referring to FIGS. 6 to 9, as previously described with reference to FIG. 1, an electrode assembly according to an embodiment of the present disclosure may include a positive electrode 10, a negative electrode 20, and a separator 30 disposed between the positive electrode 10 and the negative electrode 20.

The electrode assembly 40 may include the positive electrode 10, the separator 30, and the negative electrode 20 that are stacked in sequence. In FIGS. 6 to 9, for the convenience of description, it is illustrated as an example that the electrode assembly 40 has a structure in which one positive electrode 10 and one negative electrode 20 are respectively on an upper side and a lower side of the separator 30 with the separator 30 therebetween, but the present disclosure is not limited thereto.

For example, the electrode assembly 40 may have a structure in which a plurality of positive electrodes 10 and a plurality of negative electrodes 20 in a sheet shape are alternately stacked with a plurality of separators 30 therebetween. In embodiments, the electrode assembly may have a structure in which at least one unit cell defined as the positive electrode 10/the separator 30/the negative electrode 20 is repeatedly stacked. As another example, the electrode assembly 40 may be a jelly-roll type (or kind) in which the separator 30 is between the strip-shaped positive electrode 10 and negative electrode 20, and the laminate is wound, and then selectively pressed flat. The type (or kind) of the electrode assembly is not particularly limited, and various suitable types (or kinds), such as a stack and folding or z-folding type (or kind), may be applied.

The positive electrode 10 may include a positive electrode current collector COL1, and a positive electrode active material layer AML1 on the positive electrode current collector COL1. The positive electrode active material layer AML1 may be provided onto at least one side of the positive electrode current collector COL1. The positive electrode active material layer AML1 may be provided onto one side or both sides (e.g., two opposing sides) of the positive electrode current collector COL1.

The negative electrode 20 may include a negative electrode current collector COL2, and a negative electrode active material layer AML2 on the negative electrode current collector COL2. The negative electrode active material layer AML2 may be provided onto at least one side of the negative electrode current collector COL2. The negative electrode active material layer AML2 may be provided onto one side or both sides (or two opposing sides) of the negative electrode current collector COL2.

The separator 30 may be between the positive electrode 10 and the negative electrode 20. In embodiments, the separator 30 may be further provided onto the lowermost side. For example, the electrode assembly may also have a stack in the order of the positive electrode 10, the separator 30, the negative electrode 20, and the separator 30.

The separator 30 may separates the positive electrode 10 and the negative electrode 20, and provide a movement path of lithium ions, and any suitable separator that is generally used in a rechargeable lithium battery may be used. For example, the separator, which has low resistance to ion movement in an electrolyte solution and is excellent in impregnation of the electrolyte solution, may be used.

The separator 30 may include a porous substrate. The porous substrate may be a polymer film formed of any one polymer selected from polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may be a polyolefin-based substrate including polyolefin. The polyolefin-based substrate may have an excellent shut-down function, contributing to improvement of battery safety. The polyolefin-based substrate may include any one among, for example, a polyethylene single-layer film, a polypropylene single-layer film, a polyethylene/polypropylene two-layer film, a polyethylene/polypropylene/polyethylene three-layer film, and a polypropylene/polyethylene/polypropylene three-layer film. In an embodiment, as the porous substrate, the polypropylene/polyethylene/polypropylene three-layer film may be used.

The porous substrate may have a thickness of about 1 μm to about 40 μm, and for example, may have a thickness of about 1 μm to about 30 μm, 1 μm to about 20 μm, about 5 μm to about 15 μm, or about 5 μm to about 10 μm.

In order to secure heat resistance and/or mechanical strength, inorganic filler particles and/or an adhesive may further be included on the porous substrate.

The inorganic filler particle may include, for example, Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof. The inorganic filler particle may have a sphere shape, a plate shape, a fiber shape, and/or the like, but the shape is not limited thereto, and any suitable shape that may be used in the relevant art may be utilized.

The adhesive may include a particle-type or solution-type polymer adhesive. The polymer adhesive may include, for example, polyvinylidene fluoride (PVdF), a polyvinylidene fluoride-hexafluoropropylene (PVdFHFP) copolymer, or a combination thereof.

According to an embodiment of the present disclosure, a coating layer CTL may be provided onto one side of at least one of the positive electrode 10, the negative electrode 20, or the separator 30. For example, the coating layer CTL may be provided onto the positive electrode 10, the negative electrode 20, and/or the separator 30.

In an embodiment, referring to FIG. 6, the coating layer CTL may be provided onto one side of the positive electrode 10. The coating layer CTL may be provided onto the positive electrode active material layer AML1. In embodiments where the positive electrode active material layer AML1 is provided onto one and the other sides of the positive electrode current collector COL1, the coating layer CTL may also be provided onto each of the positive electrode active material layers AML1 respectively on the one and the other sides of the positive electrode current collector COL1.

In another embodiment, referring to FIG. 7, the coating layer CTL may be provided onto one side of the negative electrode 20. The coating layer CTL may be provided onto the negative electrode active material layer AML2. In embodiments where the negative electrode active material layer AML2 is provided onto one and the other sides of the negative electrode current collector COL2, the coating layer CTL may also be provided onto each of the negative electrode active material layers AML2 respectively on the one and the other sides of the negative electrode current collector COL2.

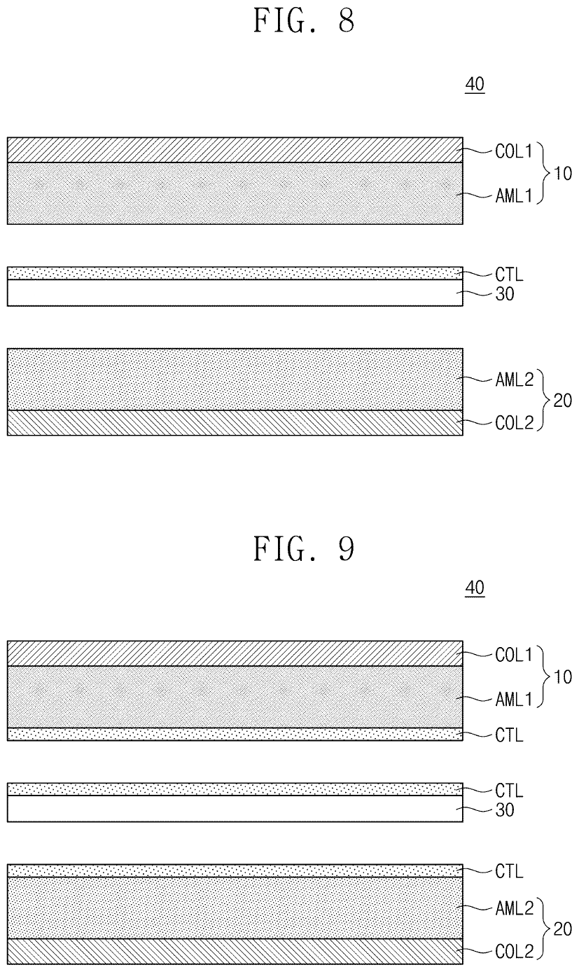

In another embodiment, referring to FIG. 8, the coating layer CTL may be provided onto one side of the separator 30. The coating layer CTL may be provided onto one side of the separator 30 facing the positive electrode 10, or provided onto the other side of the separator 30 facing the negative electrode 20. The coating layer CTL may also be provided onto both sides of the separator 30.

In another embodiment, referring to FIG. 9, the coating layer CTL may be provided onto all of one side of the positive electrode 10, one side of the negative electrode 20, and one side of the separator 30. As previously described, if (e.g., when) the active material layer AML1 or AML2 is provided onto one and the other sides of the current collector COL1 or COL2, the coating layer CTL may also be provided onto each of the active material layers AML1 or AML2 respectively on the one and the other sides of the current collector COL1 or COL2. In embodiments, the coating layer CTL may also be provided onto both sides (e.g., two opposing sides) of the separator 30.

The coating layer CTL may include a first compound. The first compound may be a maleimide-based compound including a maleimide group at the end. For example, the first compound may be a bis-maleimide-based compound including a maleimide group at both ends (e.g., two opposing ends).

The first compound may be represented by Formula 1 below, Formula 2 below, or Formula 3 below.

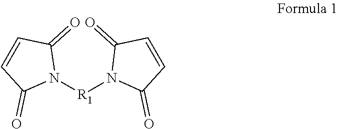

In Formula 1 above, R₁ may be a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)O—, a substituted or unsubstituted phenylene group, or a substituted or unsubstituted biphenylene group, R may be a C1 to C4 alkylene group, and R′ may be a C1 to C4 alkylene group.

For example, R₁ may be —ROR′OR—, —CH₂OCH₂—, a substituted or unsubstituted phenylene group, or a substituted or unsubstituted biphenylene group, R may be a C1 to C4 alkylene group, and R′ may be a C1 to C4 alkylene group. In embodiments, R₁ may be a substituted or unsubstituted phenylene group, or a substituted or unsubstituted biphenylene group.

Formula 1 above may be represented by any one selected from among Formula 1A to Formula 1E below.

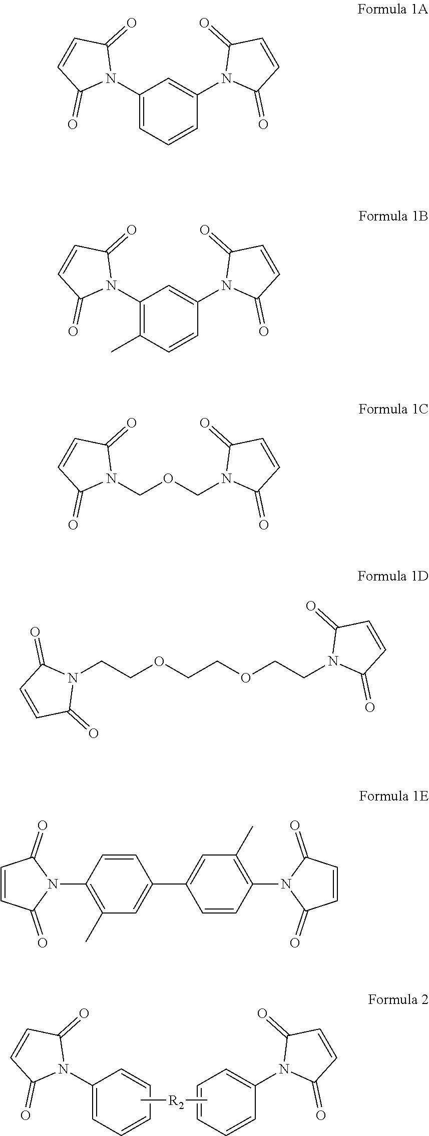

In Formula 2 above, R₂ may be a substituted or unsubstituted C1 to C4 alkylene group, —C(O)—, —C(CH₃)₂—, —O—, —O—O—, —S—, —S—S—, —(O)S(O)—, or —S(O)—.

For example, R₂ may be a substituted or unsubstituted C1 to C4 alkylene group, —C(O)—, or —C(CH₃)₂—.

Formula 2 above may be represented by any one selected from among Formula 2A to Formula 2C below.

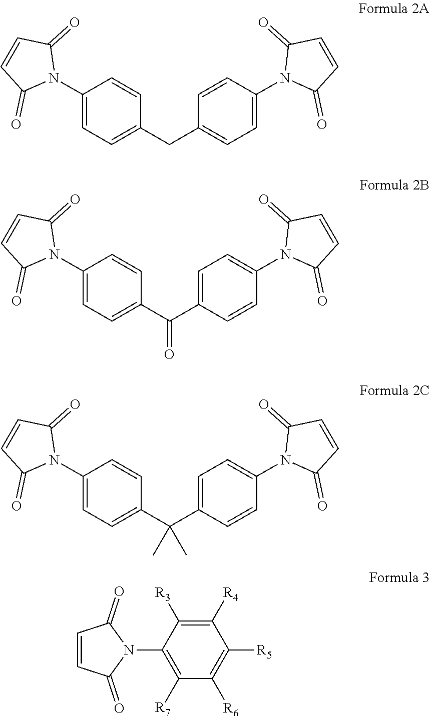

In Formula 3 above, R₃ to R₇ may be each independently hydrogen, halogen, a substituted or unsubstituted C1 to C6 alkyl group, a substituted or unsubstituted C2 to C6 alkenyl group, a substituted or unsubstituted C6 to C18 aryl group, a substituted or unsubstituted C1 to C6 ether group, or a substituted or unsubstituted C1 to C6 alkoxy group.

For example, R₃ to R₇ may be each independently hydrogen, halogen, or a substituted or unsubstituted C1 to C6 alkoxy group.

Formula 3 above may be represented by any one selected from among Formula 3A to Formula 3C below.

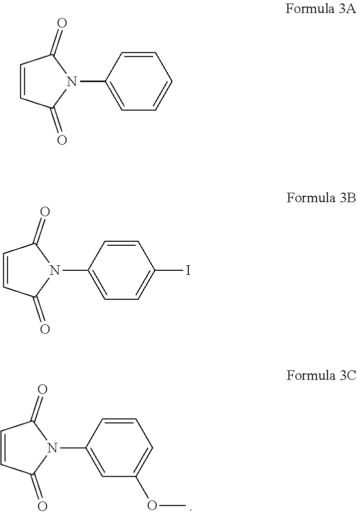

A first compound may be a monomer for radical polymerization with an unsaturated bond, capable of radical polymerization, included at an end. The first compound included in the coating layer CTL may form a polymer by initiation of a radical polymerization reaction by a second compound to be further described herein.

The coating layer CTL may be formed by dissolving the first compound in a solvent to prepare a coating solution, then applying the coating solution onto one side of at least one of the positive electrode 10, the negative electrode 20, or the separator 30, and then drying the applied coating solution.

As the solvent, for example, N-methyl-2-pyrrolidone (NMP), acetone, water, and/or the like may be used. However, an embodiment of the present disclosure is not limited thereto, and any suitable solvent that may dissolve the first compound may be used.

A method of applying the coating solution is not particularly limited, and any suitable method generally used in the art may be applied. The method of applying the coating solution may include, for example, roll coating, spray coating, a soaking method, and/or the like.

The coating layer CTL may have a thickness of about 1 μm to about 10 μm. For example, the thickness of the coating layer may be about 1 μm to about 5 μm, about 3 μm to about 7 μm, or about 6 μm to about 9 μm. If (e.g., when) the thickness of the coating layer is less than about 1 μm, it may be difficult to improve thermal safety of a battery effectively. If (e.g., when) the thickness of the coating layer is greater than about 10 μm, internal resistance (e.g., internal electrical resistance) of the battery may increase. In this specification, the “thickness” may be measured through an image photographed using an optical microscope such as a thickness gauge and/or a scanning electron microscope.

Hereinafter, a rechargeable lithium battery including the electrode assembly is described. As same components have the same or similar functions or operations, duplicate description thereof may not be repeated in the following.

A rechargeable battery according to an embodiment of the present disclosure may include the electrode assembly previously described with reference to FIGS. 6 to 9; and an electrolyte solution.

The electrolyte solution ELL may include a non-aqueous organic solvent; a lithium salt; and an additive.

The non-aqueous organic solvent may include ethylene carbonate (EC), ethyl methyl carbonate (EMC), and dimethyl carbonate (DMC). For example, the ethylene carbonate (EC) may be included in an amount of about 10 vol % to about 30 vol % on the basis of the total amount of the non-aqueous organic solvent. The ethyl methyl carbonate (EMC) may be included in an amount of about 20 vol % to about 70 vol % on the basis of the total amount of the non-aqueous organic solvent. The dimethyl carbonate (DMC) may be included in an amount of about 20 vol % to about 70 vol % on the basis of the total amount of the non-aqueous organic solvent.

The lithium salt may include one or more selected from the group consisting of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃. For example, the lithium salt may be LiPF₆.

The lithium salt may have a concentration of about 0.1 M to about 2.0 M. For example, the concentration of the lithium salt may be about 0.5 M or greater, and about 1.0 M or greater. The concentration of the lithium salt may be about 2.0 M or less, about 1.7 M or less, and about 1.5 M or less. For example, the concentration of the lithium salt may be about 1.15 M. If (e.g., when) the concentration of the lithium salt falls within the above ranges, conductivity (e.g., electrical conductivity) and viscosity of the electrolyte solution may be suitably or appropriately maintained.

The additive may include a second compound represented by Formula 4 below. The second compound is an initiator of radical polymerization, which may be a compound having a nitrogen-nitrogen double bond at the center of the compound.

The second compound may be represented by Formula 4 below.

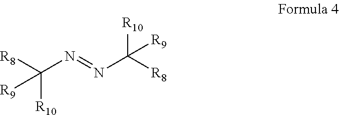

In Formula 4 above, R₈ to R₁₀ may be each independently hydrogen; a cyano group; halogen; or a substituted or unsubstituted C1 to C10 hydrocarbon group including an alkyl group, a cycloalkyl group, an alkoxy group, a carboxy group, an ester group, a carbonyl group, an amide group, or a hydroxy group, or a combination thereof.

R₈ to R₁₀ may each exist independently, or at least two thereof may be connected to each other to form a substituted or unsubstituted monocyclic or polycyclic aliphatic ring.

For example, the second compound may include at least one selected from compounds listed in Group 1 below. The compounds listed in Group 1 below are compounds in which any one selected from among R₈ to R₁₀ above is a cyano group.

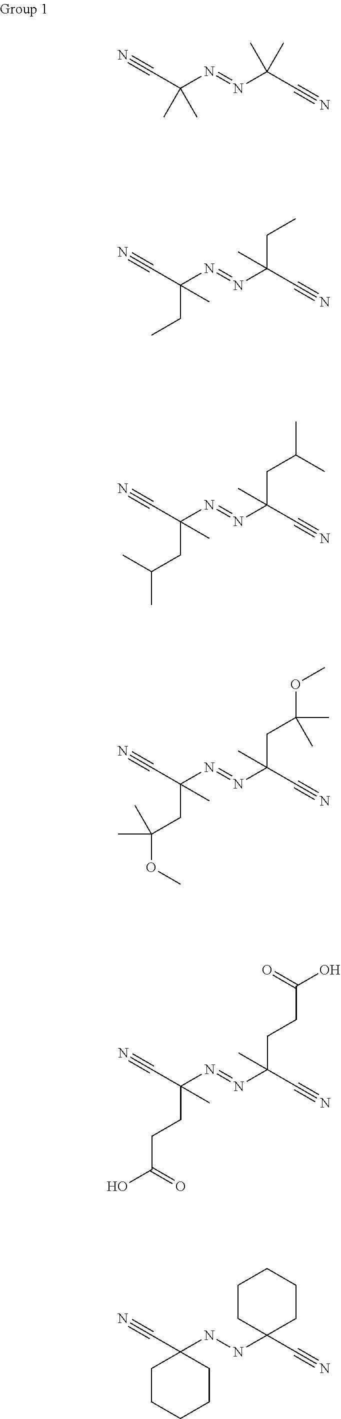

For example, Formula 4 above may include at least one selected from compounds listed in Group 2 below.

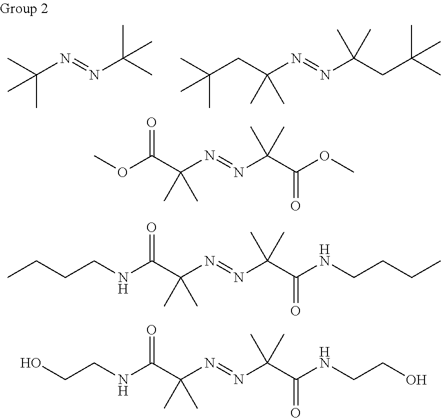

According to an embodiment of the present disclosure, by including the second compound as the additive, as previously described herein, the radical polymerization reaction of the first compound, included in the coating layer previously described herein, may be initiated to form a polymer.

In embodiments, if (e.g., when) exposed to heat or irradiated with light, the second compound may decompose to provide free radicals. The free radical may initiate a radical polymerization reaction of an unsaturated bond provided at the end of the first compound, thereby forming a polymer having the first compound as a monomer. The temperature at which the polymerization of the second compound is initiated may be about 60 °C to about 150 °C.

The second compound may be included in an amount of about 0.0001 to about 2 wt % on the basis of the total weight of the electrolyte solution. For example, the amount of the second compound may be about 0.001 to about 2 wt %, about 0.01 to about 2 wt %, about 0.1 to about 2 wt %, or about 0.1 to about 1 wt % on the basis of the total weight of the electrolyte solution. If (e.g., when) the amount of the second compound is less than about 0.0001 wt % on the basis of the total weight of the electrolyte solution, the polymerization of the first compound, previously described herein, may not be sufficiently done, so that it may be difficult to effectively improve thermal safety of a battery. If (e.g., when) the amount of the second compound is greater than about 2 wt % on the basis of the total weight of the electrolyte solution, side reaction with an electrode or an electrolyte may be caused, so that there may be a problem that charging and discharging are not properly performed.

The additive may further include a borate-based lithium salt compound.

The borate-based lithium salt compound may be represented by Formula 5 below.

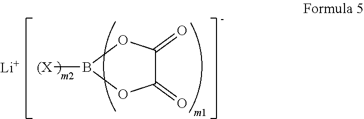

In Formula 5 above,
X may be halogen, or a C1 to C10 haloalkyl group,
m1 may be 1 or 2,
if (e.g., when) m1 is 1, m2 may be 2, and
if (e.g., when) m1 is 2, m2 may be 0.

The borate-based lithium salt compound may be at least one selected from the group consisting of lithium bis(oxalato) borate (LiBOB), and lithium difluoro (oxalato) borate (LiDFOB).

The borate-based lithium salt compound may be an amphoteric lithium salt additive that assists supplementation and absorption of lithium in the positive electrode and the negative electrode and facilitates intercalation/deintercalation of lithium in the positive electrode and negative electrode active materials to thereby improve charging and discharging characteristics of a battery.

The borate-based lithium salt compound may stabilize a lithium salt in the electrolyte solution to have the effect of protecting a film. Accordingly, it may be possible to minimize or reduce the problem of decreased lifespan of a battery which occurs if (e.g., when) the films on surfaces of the positive electrode and the negative electrode are attacked by acid that is a product of decomposition of the lithium salt in the electrolyte solution. The effect of protecting the films may contribute to improvement of lifespan characteristics of a rechargeable lithium battery.

In embodiments, because the borate-based lithium salt compound forms the films on respective surfaces of the positive electrode and the negative electrode, thermal safety and electrochemical safety of the battery may be improved and the rechargeable lithium battery may thus operate stably.

The borate-based lithium salt compound may be included in an amount of about 0.01 wt % to about 5 wt % on the basis of the total weight of the electrolyte solution. For example, the amount of the borate-based lithium salt compound may be about 0.1 wt % to about 1 wt %, about 0.5 wt % to about 2 wt %, or about 1 wt % to about 3 wt % on the basis of the total weight of the electrolyte solution. If (e.g., when) the borate-based lithium salt compound is included in an amount less than about 0.01 wt % on the basis of the total weight of the electrolyte solution, the films may not be sufficiently formed on the positive electrode and the negative electrode. If (e.g., when) the borate-based lithium salt compound is included in an amount greater than about 5 wt % on the basis of the total weight of the electrolyte solution, surface resistance (e.g., surface electrical resistance) of the positive electrode and the negative electrode may increase, so that problems may occur in securing cell performance such as securing of capacity, lifespan, and/or the like. For example, if (e.g., when) the amount of the borate-based lithium salt compound falls within the above-described ranges, increase in film resistance (e.g., film electrical resistance) may be minimized or reduced, and thus, the effect of improving the lifespan characteristics of the battery may be achieved.

The second compound and the borate-based lithium salt compound may be included in a weight ratio of about 5:1 to about 1:5. For example, the second compound and the borate-based lithium salt compound may have a weight ratio of about 3:1 to about 1:1 or about 2:1 to about 1:1.

According to an embodiment of the present disclosure, in the rechargeable lithium battery including the electrode assembly and the electrolyte solution previously described herein, the coating layer may further include a polymer obtained by polymerization with the first compound as a monomer. This is because the polymerization reaction of the first compound is initiated by an initiator (the second compound) included in the electrolyte solution. Accordingly, the coating layer may further include a polymerization output of the first compound, for example, a polymer formed through the polymerization reaction of the first compound.

For example, in the rechargeable lithium battery according to an embodiment of the present disclosure, because the coating layer is formed on the positive electrode, the negative electrode, and/or the separator, a polymer, that serves as an insulating film if (e.g., when) exposed to high temperature, may be formed to prevent short circuit (or to reduce a likelihood, occurrence, or degree thereof) caused by a contact between the positive electrode and the negative electrode. In embodiments, by providing the coating layer directly onto the positive electrode, the negative electrode, and/or the separator, a battery cell may be shut down through the polymer formed at high temperature.

In embodiments, the rechargeable lithium battery according to an embodiment of the present disclosure may have a more maximized or increased effect of shutting down the battery, for example, the more maximized or increased effect of improving thermal safety, compared to the case of including the first and second compounds as additives. This is because, if (e.g., when) the first and second compounds are included only as additives, the first and second compounds react locally inside the battery if (e.g., when) exposed to high temperature, and thus, the shut-down effect of the battery may not be exhibited properly.

Consequently, in the rechargeable lithium battery according to an embodiment of the present disclosure, explosion and ignition of the battery, if (e.g., when) exposed to high temperature, may be prevented (or a likelihood, occurrence, or degree thereof may be reduced), and thus, not only the thermal safety of the battery, but also the lifespan characteristics of the battery may be improved. Furthermore, even though the exposure of a battery cell to high temperature leads to ignition and/or explosion at an adjacent cell, and/or melting of the separator, the temperature increase of the corresponding cell may be prevented or reduced, so that the ignition and/or explosion of the cell may be prevented (or a likelihood, occurrence, or degree thereof may be reduced), and successive heat transfer to the adjacent cells may be suppressed or reduced.

According to the types or kinds of the separator and the electrolyte to be used, the rechargeable lithium battery may be classified into a lithium ion battery, a lithium ion polymer battery, and a lithium polymer battery, according to the shape, the rechargeable lithium battery may be classified into a cylindrical, prismatic, coin-type, pouch-type battery, etc., and according to the size, the rechargeable lithium battery may be classified into a bulk type and/or a thin-film type. As the structures and preparation methods of these batteries may be any suitable ones generally used in the relevant art, detailed description thereof is not necessary here.

Hereinafter, examples and comparative examples of the present disclosure are described. However, the following examples are only embodiments of the present disclosure, and the present disclosure is not limited to the following examples.

### EXAMPLE AND COMPARATIVE EXAMPLE

An electrode assembly and a rechargeable lithium battery were prepared in a method as follows.

### Example 1

### 1 Preparation of Electrode Assembly

LiNi_{0.91}Co_{0.07}Al_{0.02}O₂ as a positive electrode active material, polyvinylidene fluoride as a binder, and ketjen black as a conductive material were mixed in a weight ratio of about 97:2:1, and the mixture was dispersed in N-methylpyrrolidone to prepare a positive electrode active material slurry.

The positive electrode active material slurry was applied onto an aluminum current collector having a thickness of about 12 μm, using a doctor blade, such that the thickness of the applied slurry became about 60 μm, and the applied slurry was dried and pressed to prepare a positive electrode.

A first compound (1,1′-(methylenedi-4,1-phenylene)bismaleimide, BMI), represented by Formula 2A below, was dissolved in an N-methylpyrrolidone solvent to prepare a coating solution. The coating solution was applied onto the positive electrode in a thickness of about 4 μm in a die coating method, and then dried to form a coating layer.

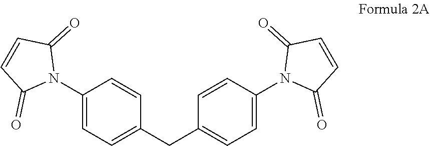 [SMILES: O=C1C=CC(=O)N1c1ccc(Cc2ccc(N3C(=O)C=CC3=O)cc2)cc1]

Artificial graphite as a negative electrode active material, a styrene-butadiene rubber as a binder, and carboxymethyl cellulose as a thickener were mixed in a weight ratio of about 97:2:1, and the mixture was dispersed in distilled water to prepare a negative electrode active material slurry.

The negative electrode active material slurry was applied onto a copper current collector having a thickness of about 10 μm, using a doctor blade, such that the thickness of the applied slurry became about 60 μm, and the applied slurry was dried and pressed to prepare a negative electrode.

A separator of polyethylene/polypropylene/polyethylene (about 2 μm/about 10 μm/about 2 μm) in a thickness of about 14 μm was provided between the prepared positive electrode and negative electrode to prepare an electrode assembly.

### 2 Preparation of Rechargeable Lithium Battery

The electrode assembly was inserted in a prismatic case, and then an electrolyte solution was injected to prepare a rechargeable lithium battery. The composition of the electrolyte solution was as below.

### Composition of Electrolyte Solution

A lithium salt: LiPF₆ with about 1.15 M
A non-aqueous organic solvent:ethylene carbonate (EC):ethyl methyl carbonate (EMC):dimethyl carbonate (DMC) (in a volume ratio of about 20:40:40).
An additive: a second compound (2,2′-azobis(isobutyronitrile), AIBN), represented by Formula 4A below, in an amount of about 1 wt %.

(In the composition of electrolyte solution described herein, “wt %” is on the basis of the total weight of the electrolyte solution)

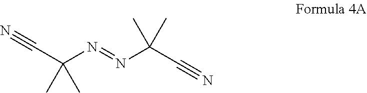

### Example 2

An electrode assembly and a rechargeable lithium battery were prepared in substantially the same manner as that of Example 1, except that the coating layer was formed on the negative electrode.

### Example 3

An electrode assembly and a rechargeable lithium battery were prepared in substantially the same manner as that of Example 1, except that the coating layer was formed on the separator.

### Example 4

An electrode assembly and a rechargeable lithium battery were prepared in substantially the same manner as that of Example 1, except that the coating layer was formed on the positive electrode, the negative electrode, and the separator, and the coating layer was applied in a thickness of about 1 μm.

### Example 5

An electrode assembly and a rechargeable lithium battery were prepared in substantially the same manner as that of Example 4, except that a compound (LiBOB) represented by Formula 5A below was further added in an amount of about 0.5 wt % as an additive in preparation of an electrolyte solution.

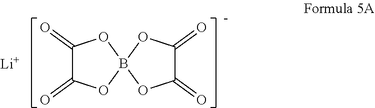

### Example 6

An electrode assembly and a rechargeable lithium battery were prepared in substantially the same manner as that of Example 4, except that a compound (LiDFOB) represented by Formula 5B below was further added in an amount of about 0.5 wt % as an additive in preparation of an electrolyte solution.

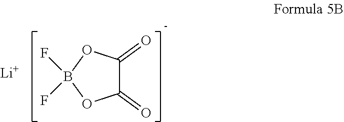

### Comparative Example 1

An electrode assembly was prepared in substantially the same manner as that of Example 1, except that the coating layer was not formed. A rechargeable lithium battery was prepared in substantially the same manner as that of Example 1, except that an additive was not added in preparation of an electrolyte solution.

### Comparative Example 2

An electrode assembly and a rechargeable lithium battery were prepared in substantially the same manner as that of Comparative Example 1, except that BMI was added in an amount of about 4 wt % as an additive in preparation of an electrolyte solution.

### Comparative Example 3

An electrode assembly and a rechargeable lithium battery were prepared in substantially the same manner as that of Comparative Example 1, except that AIBN was added in an amount of about 1 wt % as an additive in preparation of an electrolyte solution.

### Comparative Example 4

An electrode assembly and a rechargeable lithium battery were prepared in substantially the same manner as that of Comparative Example 1, except that BMI in an amount of about 4 wt % and AIBN in an amount of about 1 wt % were added as additives in preparation of an electrolyte solution.

### Comparative Example 5

An electrode assembly and a rechargeable lithium battery were prepared in substantially the same manner as that of Comparative Example 1, except that LiBOB was added in an amount of about 0.5 wt % as an additive in preparation of an electrolyte solution.

### Comparative Example 6

An electrode assembly and a rechargeable lithium battery were prepared in substantially the same manner as that of Comparative Example 1, except that LiDFOB was added in an amount of about 0.5 wt % as an additive in preparation of an electrolyte solution.

### Comparative Example 7

An electrode assembly and a rechargeable lithium battery were prepared in substantially the same manner as that of Comparative Example 1, except that the coating layer having a thickness of about 4 μm was formed on the positive electrode.

### Comparative Example 8

An electrode assembly and a rechargeable lithium battery were prepared in substantially the same manner as that of Comparative Example 1, except that the coating layer having a thickness of about 4 μm was formed on the negative electrode.

### Comparative Example 9

An electrode assembly and a rechargeable lithium battery were prepared in substantially the same manner as that of Comparative Example 1, except that the coating layer having a thickness of about 4 μm was formed on the separator.

### Evaluation Example 1: Heat Exposure Evaluation

The rechargeable lithium batteries according to Examples 1 to 6 and Comparative Examples 1 to 9 in a discharged state at about 2.8 V were charged at a C-rate of about 0.33 C in a condition of about 4.25 V/3 hr cut-off, and then heat exposure evaluation was performed. The rechargeable lithium battery according to each of Examples 1 to 6 and Comparative Examples 1 to 9 was placed in a chamber, and then the temperature was increased from room temperature to about 170 °C and about 180 °C at a temperature increase rate of about 5 °C per minute, and while maintained at the above temperature for about 30 minutes, changes in the rechargeable lithium batteries were observed, and the results were listed in Table 1 below.

In Table 1, if there was no problem, it was marked with “OK”, and if sudden thermal runaway occurred, it was marked with “NG”. The evaluation was performed as above on three of each, and the number of batteries were marked before OK or NG.

### Evaluation Example 2: Evaluation on Lifespan Characteristics at Room Temperature

3 cycles of charging and discharging were performed with about 0.33 C on the rechargeable lithium batteries, according to Examples 1 to 6 and Comparative Examples 1 to 9, and the charge/discharge capacities were measured (initial capacity).

At room temperature (about 25 °C), a charging and discharging experiment was performed 500 times under conditions of 0.33 C charging (CC/CV, 4.25 V, 0.05 C cut-off)/0.5 C discharging (CC, 2.8 V cut-off), and the discharge capacities at the 500th cycle were measured.

The ratio of the discharge capacity at the 500th cycle to the initial capacity was calculated, and the results were listed as the capacity retention rates (%) in Table 1 below.

TABLE 1

| | | | Lifespan characteristics at room |
|---|---|---|---|
| | Heat exposure | | temperature (about 25 °C, 500 |
| | characteristics | | cycles) |
| | 170 °C | 180 °C | Capacity retention rate (%) |
| Example 1 | 3 OK | 1 OK, 2 NG | 86.8 |
| Example 2 | 3 OK | 1 OK, 2 NG | 85.3 |
| Example 3 | 3 OK | 1 OK, 2 NG | 85.8 |
| Example 4 | 3 OK | 3 OK | 87.1 |
| Example 5 | 3 OK | 3 OK | 91.2 |
| Example 6 | 3 OK | 3 OK | 90.5 |
| Comparative | 3 NG | 3 NG | 88.6 |
| Example 1 | | | |
| Comparative | 3 NG | 3 NG | 85.9 |
| Example 2 | | | |
| Comparative | 3 NG | 3 NG | 87.4 |
| Example 3 | | | |
| Comparative | 3 OK | 3 NG | 84.3 |
| Example 4 | | | |
| Comparative | 3 NG | 3 NG | 92.4 |
| Example 5 | | | |
| Comparative | 3 NG | 3 NG | 91.8 |
| Example 6 | | | |
| Comparative | 3 NG | 3 NG | 87.4 |
| Example 7 | | | |
| Comparative | 3 NG | 3 NG | 86.9 |
| Example 8 | | | |
| Comparative | 3 NG | 3 NG | 87.7 |
| Example 9 | | | |

Referring to Table 1, in Example 1 where the coating layer was formed on the positive electrode, Example 2 where the coating layer was formed on the negative electrode, and Example 3 where the coating layer was formed on the separator, it can be seen that heat-exposure characteristics were excellent. In addition, in Examples 4 to 6 where the coating layer was formed on the positive electrode, the negative electrode, and the separator, it can be seen that the heat-exposure characteristics were also excellent. Furthermore, in Examples 5 and 6 where the borate-based lithium salt compound was further included as an additive, it can be seen that the capacity retention rates were improved.

On the other hand, in Comparative Examples 1 to 6 where the coating layer was not formed, it can be seen that the heat-exposure characteristics were relatively low, compared to Examples 1 to 6. This may be because a polymerization reaction of the first compound was not initiated, and thus the shut-down function was not activated.

In Comparative Example 4 where the first compound and the second compound were added to the electrolyte solution only as additives, it can be seen that the battery had no problem at about 170 °C, but thermal runaway was observed at about 180 °C or higher. Unlike the examples where the coating layer including the first compound was formed and the electrolyte solution including the second compound as an additive was used, in Comparative Example 4, the battery shut-down effect was not sufficiently exhibited because the polymer was formed locally inside the battery.

In Comparative Examples 7 to 9 where the coating layer was formed but the additive was not added, it can be seen that, because the polymerization reaction of the first compound was not initiated, the shut-down function was not activated, and thus, the heat-exposure characteristics decreased.

Furthermore, in Comparative Examples 5 and 6, it can be seen that, because the borate-based lithium salt compound was included as the additive, the level of lifespan characteristics at room temperature, same as those of Examples 5 and 6, were achieved, but the heat-exposure characteristics decreased.

An electrode assembly and a rechargeable lithium battery according to an embodiment of the present disclosure may prevent explosion and ignition (or reduce a likelihood, occurrence, or degree thereof) of the battery if (e.g., when) exposed to high temperature, and may prevent or reduce the temperature increase of the battery, and thermal safety and lifespan may thus be improved.

Although embodiments of the present disclosure have been described with reference to the accompanying drawings, it is understood that the present disclosure should not be limited to these embodiments but various suitable changes and modifications can be made within the scope of the claims, the detailed description of the present disclosure, and the accompanying drawings, and this also falls within the scope of the present disclosure.

What is claimed is:

1. An electrode assembly comprising:
a positive electrode;
a negative electrode; and
a separator between the positive electrode and the negative electrode,
wherein a coating layer is provided onto one side of at least one of the positive electrode, the negative electrode, or the separator, and
the coating layer comprises a first compound represented by Formula 1 below, Formula 2 below, or Formula 3 below: 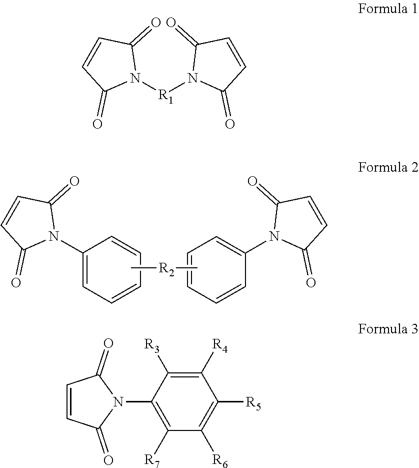
where, in Formula 1 above, R₁ is a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)O—, a substituted or unsubstituted phenylene group, or a substituted or unsubstituted biphenylene group, R is a C1 to C4 alkylene group, and R′ is a C1 to C4 alkylene group,
in Formula 2 above, R₂ is a substituted or unsubstituted C1 to C4 alkylene group, —C(O)—, —C(CH₃)₂—, —O—, —O—O—, —S—, —S—S—, —(O)S(O)—, or —S(O)—, and
in Formula 3 above, R₃ to R₇ are each independently hydrogen, halogen, a substituted or unsubstituted C1 to C6 alkyl group, a substituted or unsubstituted C2 to C6 alkenyl group, a substituted or unsubstituted C6 to C18 aryl group, a substituted or unsubstituted C1 to C6 ether group, or a substituted or unsubstituted C1 to C6 alkoxy group.

2. The electrode assembly as claimed in claim 1, wherein R₁ of Formula 1 above is —ROR′OR—, —CH₂OCH₂—, a substituted or unsubstituted phenylene group, or a substituted or unsubstituted biphenylene group, R is a C1 to C4 alkylene group, and R′ is a C1 to C4 alkylene group.

3. The electrode assembly as claimed in claim 1, wherein Formula 1 above is represented by any one selected from among Formula 1A to Formula 1E below:

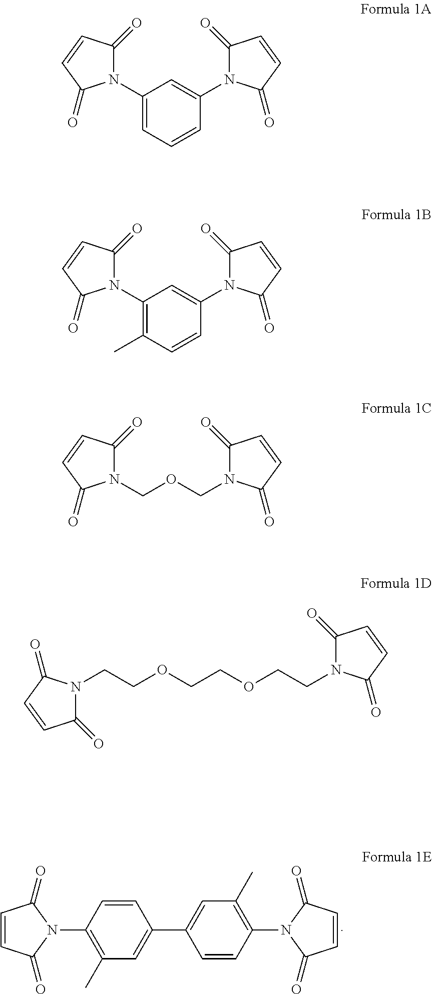 [SMILES: O=C1C=CC(=O)N1c1cccc(N2C(=O)C=CC2=O)c1 ; Cc1ccc(N2C(=O)C=CC2=O)cc1N1C(=O)C=CC1=O ; O=C1C=CC(=O)N1COCN1C(=O)C=CC1=O ; O=C1C=CC(=O)N1CCOCCOCCN1C(=O)C=CC1=O ; Cc1cc(-c2ccc(N3C(=O)C=CC3=O)c(C)c2)ccc1N1C(=O)C=CC1=O]

4. The electrode assembly as claimed in claim 1, wherein R₂ of Formula 2 above is a substituted or unsubstituted C1 to C4 alkylene group, —C(O)—, or —C(CH₃)₂—.

5. The electrode assembly as claimed in claim 1, wherein Formula 2 above is represented by any one selected from among Formula 2A to Formula 2C below:

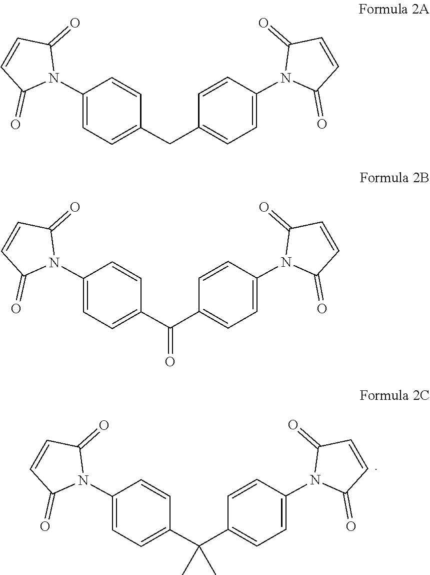 [SMILES: O=C1C=CC(=O)N1c1ccc(Cc2ccc(N3C(=O)C=CC3=O)cc2)cc1 ; O=C(c1ccc(N2C(=O)C=CC2=O)cc1)c1ccc(N2C(=O)C=CC2=O)cc1 ; CC(C)(c1ccc(N2C(=O)C=CC2=O)cc1)c1ccc(N2C(=O)C=CC2=O)cc1]

6. The electrode assembly as claimed in claim 1, wherein R₃ to R₇ of Formula 3 above are each independently hydrogen, halogen, or a substituted or unsubstituted C1 to C6 alkoxy group.

7. The electrode assembly as claimed in claim 1, wherein Formula 3 above is represented by any one selected from among Formula 3A to Formula 3C below:

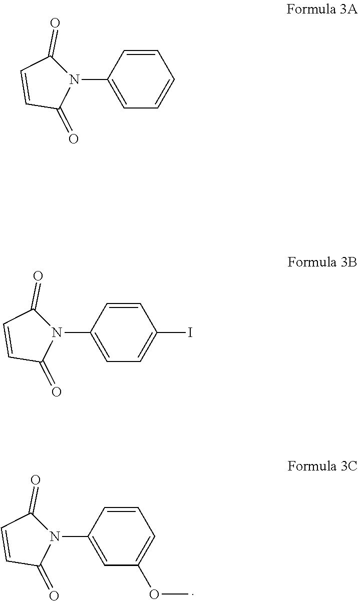

8. The electrode assembly as claimed in claim 1, wherein the coating layer has a thickness of about 1 μm to about 10 μm.

9. A rechargeable lithium battery comprising:
the electrode assembly as claimed in claim 1; and
an electrolyte solution,
wherein the electrolyte solution comprises a non-aqueous organic solvent; a lithium salt; and an additive, and
the additive comprises a second compound represented by Formula 4 below: 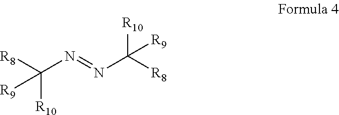
where, in Formula 4 above, R₈ to R₁₀ are each independently hydrogen; a cyano group; halogen; or a substituted or unsubstituted C1 to C10 hydrocarbon group including an alkyl group, a cycloalkyl group, an alkoxy group, a carboxy group, an ester group, a carbonyl group, an amide group, or a hydroxy group, or a combination thereof, and
each of R₈ to R₁₀ exists independently, or at least two thereof are connected to each other to form a substituted or unsubstituted monocyclic or polycyclic aliphatic ring.

10. The rechargeable lithium battery as claimed in claim 9, wherein the second compound comprises at least one selected from compounds listed in Group 1 below:

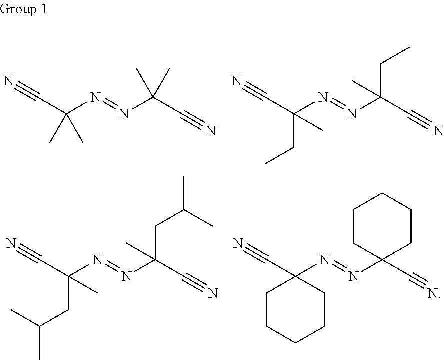

11. The rechargeable lithium battery as claimed in claim 9, wherein the additive further comprises a borate-based lithium salt compound.

12. The rechargeable lithium battery as claimed in claim 11, wherein the borate-based lithium salt compound is represented by Formula 5 below: 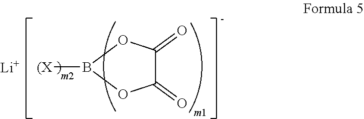
wherein, in Formula 5 above,
X is halogen, or a C1 to C10 haloalkyl group,
m1 is 1 or 2,
if m1 is 1, m2 is 2, and
if m1 is 2, m2 is 0.

13. The rechargeable lithium battery as claimed in claim 11, wherein the borate-based lithium salt compound is at least one selected from the group consisting of lithium bis(oxalato) borate (LiBOB) and lithium difluoro (oxalato) borate (LiDFOB).

14. The rechargeable lithium battery as claimed in claim 9, wherein the second compound is included in an amount of about 0.0001 wt % to about 2 wt % on the basis of a total weight of the electrolyte solution.

15. The rechargeable lithium battery as claimed in claim 11, wherein the borate-based lithium salt compound is included in an amount of about 0.01 wt % to about 5 wt % on the basis of a total weight of the electrolyte solution.

16. The rechargeable lithium battery as claimed in claim 11, wherein the second compound and the borate-based lithium salt compound are included in a weight ratio of about 5:1 to about 1:5.

17. The rechargeable lithium battery as claimed in claim 9, wherein the non-aqueous organic solvent comprises a carbonate-based solvent, and
the carbonate-based solvent comprises ethylene carbonate (EC), ethyl methyl carbonate (EMC), and dimethyl carbonate (DMC).

18. The rechargeable lithium battery as claimed in claim 9, wherein the lithium salt is LiPF₆.

19. The rechargeable lithium battery as claimed in claim 9, wherein the lithium salt has a concentration of about 0.1 M to about 2.0 M.

20. The rechargeable lithium battery as claimed in claim 9, wherein the coating layer further comprises a polymer obtained by polymerization of the first compound as a monomer.
